(19) United States
(12) Patent Application Publication
(10) Pub. No.: US 2006/0125727 A1
(43) Pub. Date: Jun. 15, 2006

(54) Plasma display apparatus and driving method thereof

(75) Inventors: Jong Woon Kwak, Anyang-si (KR); Tae Hyung Kim, Seoul (KR); Seong Hak Moon, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/302,430

(22) Filed: Dec. 14, 2005

(30) Foreign Application Priority Data
Dec. 14, 2004 (KR) 10-2004-0105771
Dec. 14, 2004 (KR) 10-2004-0105776

(51) Int. Cl. G09G 3/28

(52) U.S. Cl. 345/68

(57) ABSTRACT

The present invention relates to a display apparatus, and more particularly, to a plasma display apparatus and driving method thereof. The plasma display apparatus according to an embodiment of the present invention comprises a plasma display panel comprising a scan electrode and a sustain electrode, a first voltage supply unit connected to the scan electrode and the sustain electrode, for supplying a first voltage to the scan electrode or the sustain electrode during a sustain period, and a second voltage supply unit connected to the scan electrode and the sustain electrode, for supplying a second voltage with a polarity inverse to the polarity of the first voltage to an electrode counter to an electrode to which the first voltage is supplied during the sustain period. Therefore, a scan driver and a sustain driver for driving the scan electrode and the sustain electrode are not separately comprised. The construction of a circuit can be simplified and an amount in which an element is used can be reduced. It is also possible to lower a voltage level of a driving pulse.

### CROSS-REFERENCES TO RELATED APPLICATIONS

This Nonprovisional application claims priority under 35 U.S.C. § 119(a) on Patent Application Nos. 10-2004-0105771 and 10-2004-0105776 filed in Korea on Dec. 14, 2005, the entire contents of which are hereby incorporated by reference.

### BACKGROUND OF THE INVENTION

1. Field of the Invention

The present document relates to a display apparatus, and more particularly, to a plasma display apparatus and driving method thereof.

2. Background of the Related Art

A plasma display apparatus displays images by exciting phosphors with ultraviolet generated when a mixed inert gas such as He+Xe, Ne+Xe or He+Ne+Xe is discharged. The plasma display apparatus can be easily made thin and large, and it can provide greatly increased image quality with the recent development of the relevant technology.

FIG. 1 is a view illustrating a method of implementing images of a plasma display apparatus.

Referring to FIG. 1, the plasma display apparatus is time-driven with one frame being divided into several subfields having a different number of emissions in order to implement gray levels of an image. Each of the subfields is divided into a reset period for initializing the entire screen, an address period for selecting a scan line and selecting a discharge cell from the selected scan line, and a sustain period for implementing gray levels according to a discharge number.

For example, if it is sought to display an image with 256 gray levels, one frame period (16.67 ms) corresponding to 1/60 seconds is divided into eight subfields (SF1 to SF8). Each of the subfields (SF1 to SF8) is divided into a reset period, an address period and a sustain period as described above. The reset period and the address period of each subfield are the same every subfield, whereas the sustain period and the number of sustain pulses allocated thereto increase in the ratio of 2ⁿ (where, n=0, 1, 2, 3, 4, 5, 6, 7) in each subfield.

FIG. 2 shows a driving waveform of the plasma display apparatus in the related art.

Referring to FIG. 2, each of sub-fields (SF) comprises a reset period (RP) for initializing discharge cells of the entire screen, an address period (AP) for selecting discharge cells, and a sustain period (SP) for sustaining the discharge of selected discharge cells.

In a set-up period (SU) of the reset period (RP), a ramp-up waveform (PR) is applied to the entire scan electrodes Y at the same time. A weak discharge (a set-up discharge) is generated within cells of the entire screen by the ramp-up waveform (PR), thus generating wall charges within the cells. In the set-up period (SD) of the reset period (RP), a ramp-down waveform (NR), which falls from a positive (+) sustain voltage (Vs) lower than a peak voltage of the ramp-up waveform (PR) to a negative scan voltage (−Vy) at a predetermined slant, is applied to the scan electrodes Y at the same time. The ramp-down waveform (NR) generates a weak erase discharge within the cells to erase wall charges generated by the set-up discharge and unnecessary charges of spatial charges, thus allowing wall charges necessary for an address discharge to uniformly remain within the cells of the entire screen.

In the address period (AP), while a negative (−) scan pulse (SCNP) is sequentially applied to the scan electrodes Y, a positive (+) data pulse (DP) is applied to address electrodes X. As a voltage difference between the scan pulse (SCNP) and the data pulse (DP) and a wall voltage generated in the reset period (RP) are added, an address discharge is generated within cells to which the data pulse (DP) is applied. Wall charges are generated within cells selected by an address discharge. Meanwhile, during the set-up period (SD) and the address period (AP), a positive (+) sustain voltage (Vs) is applied to sustain electrodes Z.

In the sustain period (SP), a sustain pulse (SUSP) is alternately applied to the scan electrodes Y and the sustain electrodes Z. Therefore, a sustain discharge is generated in a surface discharge form between the scan electrodes Y and the sustain electrodes Z in cells selected by the address discharge whenever the sustain pulse (SUSP) is applied as the wall voltage within the cells and the sustain pulse (SUSP) are added. The sustain pulse (SUSP) has the same voltage value as the sustain voltage (Vs).

FIG. 3 is a circuit diagram of the plasma display apparatus in the related art.

Referring to FIG. 3, the related art plasma display apparatus comprises a sustain pulse supply unit 2, a set-up voltage supply controller 6, a set-down voltage supply controller 8, a scan voltage supply controller 10, a scan reference voltage supply controller 12, a scan Integrated Circuit (IC) 14, a tenth switch SW10 and an eleventh switch SW11. A panel capacitor Cp equivalently shows capacitance formed between the scan electrode Y and the sustain electrode Z of the plasma display apparatus. Furthermore, in FIG. 3, only a scan driver for driving the scan electrode Y is shown, but a sustain driver for driving the sustain electrode Z is omitted. That is, the prior art plasma display apparatus includes a sustain driver comprising a sustain pulse supply unit, which is the same as the sustain pulse supply unit 2 of FIG. 3, etc. in order to supply a sustain pulse to the sustain electrode Z.

The sustain pulse supply unit 2 supplies a sustain voltage level (Vs) and a sustain pulse (SUSP) having a ground voltage level (GND) to the scan electrode Y of the panel capacitor Cp during the sustain period (SP). The sustain pulse supply unit 2 consists of a sustain voltage supply controller 16 and a ground voltage supply controller 18.

The sustain voltage supply controller 16 controls the sustain voltage (Vs) to be supplied to the scan electrode Y of the panel capacitor Cp during the set-up period (SU) of the reset period (RP) and the sustain period (SP). The sustain voltage supply controller 16 comprises a first switch SW1 connected between the sustain voltage source (Vs) and a first node N1.

The ground voltage supply controller 18 controls the ground voltage (GND) to be supplied to the scan electrode Y of the panel capacitor Cp during the sustain period (SP). The ground voltage supply controller 18 comprises a second switch SW2 connected between the ground voltage source (GND) and the first node N1.

The set-up voltage supply controller 6 controls the ramp-up waveform (PR), which rises from a sustain voltage (Vs) to a peak voltage (Vs+Vsetup) at a predetermined slant as shown in FIG. 2, to be supplied to the scan electrode Y of the panel capacitor Cp during the set-up period (SU) of the reset period (RP). The set-up voltage supply controller 6 comprises a third switch SW3 connected between the set-up voltage source (Vsetup) and a second node N2, a first variable resistor R1 connected to the gate terminal of the third switch SW3, for controlling the slant of the ramp-up waveform (PR), and a first capacitor C1 connected between the set-up voltage source (Vsetup) and the first node N1.

The set-down voltage supply controller 8 controls the ramp-down waveform (NR), which falls from the sustain voltage (Vs) to a set-down voltage (−Vy) at a predetermined slant as shown in FIG. 2, to be supplied to the scan electrode Y of the panel capacitor Cp during the set-down period (SD) of the reset period (RP). The set-down voltage supply controller 8 comprises a fourth switch SW4 connected between a scan voltage source (−Vy) and a third node N3, and a second variable resistor R2 connected to the gate terminal of the fourth switch SW4, for controlling the slant of the ramp-down waveform (NR).

The scan voltage supply controller 10 controls the scan voltage (−Vy) as shown in FIG. 2 to be supplied to the scan electrode Y of the panel capacitor Cp during the address period (AP). The scan voltage supply controller 10 comprises a fifth switch SW5 connected parallel to the fourth switch SW4 connected between the scan voltage source (−Vy) and the third node N3.

The scan reference voltage supply controller 12 controls a scan reference voltage (Vsc) as shown in FIG. 2 to be supplied to the scan electrode Y of the panel capacitor Cp during the address period (AP). The scan reference voltage supply controller 12 comprises a sixth switch SW6 and a seventh switch SW7 connected in series between a scan reference voltage source (Vsc) and the third node N3, and a second capacitor C2 connected between the scan reference voltage source (Vsc) and the third node N3.

The scan IC 14 comprises an eighth switch SW8 and a ninth switch SW9 connected between a fourth node N4 and the third node N3 in a push-pull form. The eighth switch SW8 connects the scan electrode Y of the panel capacitor Cp to the fourth node N4 via its body diode. The ninth switch SW9 connects the third node N3 to the scan electrode Y of the panel capacitor Cp via its body diode.

The tenth switch SW10 is connected between the first node N1 and the second node N2 and electrically connects the first node N1 to the second node N2 via its body diode. Furthermore, the tenth switch SW10 electrically connects the first node N1 to the second node N2 in response to a tenth switching control signal supplied from a timing controller (not shown).

The eleventh switch SW11 electrically connects the second node N2 to the third node N3 in response to an eleventh switching control signal supplied from the timing controller (not shown).

As described above, in the related art, to drive the plasma display apparatus, a number of DC power supplies having voltage levels, such as the set-up voltage (Vsetup), the sustain voltage (Vs), the ground voltage (GND), the scan reference voltage (Vsc), the data voltage (Va) and the scan voltage (−Vy), are required. The sustain voltage (Vs), the ground voltage (GND) and the data voltage (Va) are supplied from a power board (not shown). The remaining power supplies such as the set-up voltage (Vsetup), the scan voltage (−Vy) and the scan reference voltage (Vsc) are generated by DC-DC converting the sustain voltage (Vs) so that it is suitable for each voltage level. As described above, in the prior art plasma display apparatus driving apparatus, a number of DC-DC conversion circuits for converting the level of each power are required. Therefore, a problem arises because the cost of a plasma display apparatus increases. That is, the prior art plasma display apparatus uses lots of elements that can stand a driving waveform of a high frequency, a high voltage and a high current. Therefore, the manufacturing cost is high.

There is also a problem in that the efficiency of products is low due to heat and noise generated in elements when the plasma display apparatus is driven.

### SUMMARY OF THE INVENTION

Accordingly, an object of the present invention is to solve at least the problems and disadvantages of the background art.

It is an object of the present invention to provide a plasma display apparatus and driving method thereof, in which the number of power supply necessary to drive a plasma display apparatus is reduced to save the cost.

It is another object of the present invention to provide a plasma display apparatus and driving method thereof, in which the prime cost can be saved and the efficiency of a circuit can be enhanced using a low rating element in comparison with the prior art.

To achieve the above objects, a plasma display apparatus according to an embodiment of the present invention comprises a plasma display panel comprising a scan electrode and a sustain electrode, a first voltage supply unit connected to the scan electrode and the sustain electrode, for supplying a first voltage to the scan electrode or the sustain electrode during a sustain period, and a second voltage supply unit connected to the scan electrode and the sustain electrode, for supplying a second voltage with a polarity inverse to the polarity of the first voltage to an electrode counter to an electrode to which the first voltage is supplied during the sustain period.

A plasma display apparatus according to another embodiment of the present invention comprises a plasma display panel comprising a scan electrode and a sustain electrode, a first voltage supply unit connected to the scan electrode and the sustain electrode, for supplying a first voltage to the sustain electrode during an address period and for supplying the first voltage to the scan electrode or the sustain electrode during a sustain period, and a second voltage supply unit connected to the scan electrode and the sustain electrode, for supplying a second voltage with a polarity inverse to the polarity of the first voltage to an electrode counter to an electrode to which the first voltage is supplied during the sustain period.

The present invention further provides a method of driving a plasma display apparatus that implements images during one frame by combining a plurality of subfields, each comprising a set-up period, a set-down period, an address period and a sustain period, the method comprising the steps of supplying a first voltage to a sustain electrode during the address period, and supplying the first voltage to any one of a scan electrode and the sustain electrode during the sustain period, and supplying a second voltage with a polarity inverse to the polarity of the first voltage to an electrode counter to an electrode to which the first voltage is supplied.

In accordance with a plasma display apparatus and driving method thereof of the present invention, the number of power supply necessary to drive a plasma display apparatus can be reduced. Therefore, there is an advantage in that the cost can be saved.

In accordance with a plasma display apparatus and driving method thereof of the present invention, a low rating element is used in comparison with the prior art. Therefore, there are advantages in that the prime cost can be saved and the efficiency of a circuit can be enhanced.

### BRIEF DESCRIPTION OF THE DRAWINGS

The invention will be described in detail with reference to the following drawings in which like numerals refer to like elements.

FIG. 1 is a view illustrating a method of implementing images of a plasma display apparatus;

FIG. 2 shows a driving waveform of the plasma display apparatus in the related art;

FIG; 3: is a circuit diagram of the plasma display apparatus in the related art;

FIG. 4 is a circuit diagram of a plasma display apparatus according to a first embodiment of the present invention;

FIG. 5 is a view illustrating a driving waveform of the plasma display apparatus according to a first embodiment of the present invention;

FIG. 6 is a circuit diagram of a plasma display apparatus according to a second embodiment of the present invention; and

FIG. 7 is a view illustrating a driving waveform of the plasma display apparatus according to a second embodiment of the present invention.

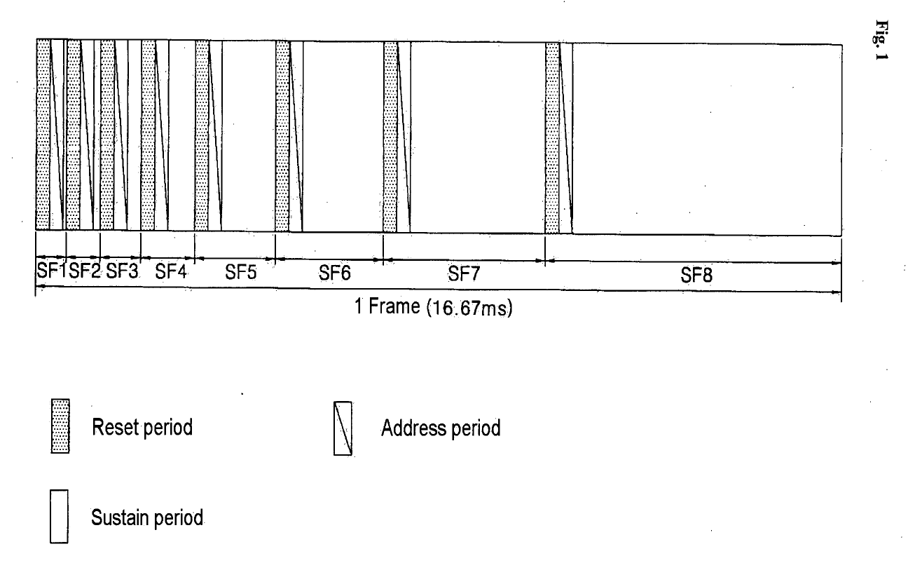

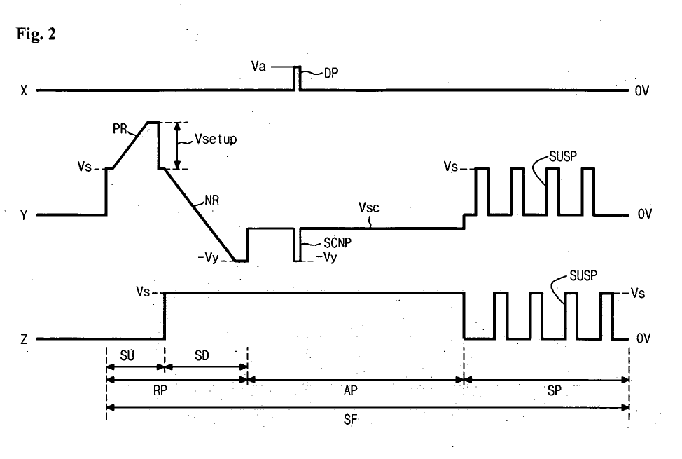

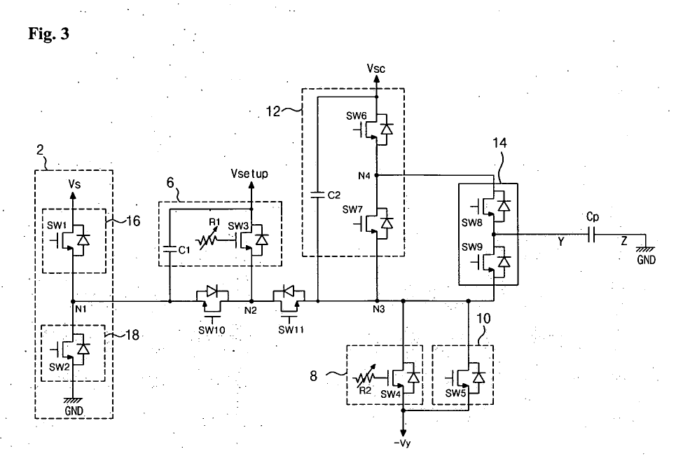

### DETAILED DESCRIPTION OF THE PREFERRED EMBODIMENT

Preferred embodiments of the present invention will be described in a more detailed manner with reference to the drawings.

A plasma display apparatus according to an embodiment of the present invention comprises a plasma display panel comprising a scan electrode and a sustain electrode, a first voltage supply unit connected to the scan electrode and the sustain electrode, for supplying a first voltage to the scan electrode or the sustain electrode during a sustain period, and a second voltage supply unit connected to the scan electrode and the sustain electrode, for supplying a second voltage with a polarity inverse to the polarity of the first voltage to an electrode counter to an electrode to which the first voltage is supplied during the sustain period.

A voltage difference between the first voltage and the second voltage is the voltage level for a sustain discharge voltage (Vs).

A voltage level of the first voltage is Vs/2.

A voltage level of the second voltage is −Vs/2.

The plasma display apparatus further comprises a third voltage supply unit for supplying a third voltage to the scan electrode during a set-up period.

The first voltage supply unit and the third voltage supply unit supply a combination of the first voltage and the third voltage to the scan electrode during the set-up period. The second voltage supply unit supplies the second voltage to the sustain electrode.

The third voltage supply unit comprises a first switch connected to a first variable resistor, and supplies the third voltage through the first switch during the set-up period.

The second voltage supply unit supplies the second voltage to the scan electrode during a set-down period. The first voltage supply unit supplies the first voltage to the sustain electrode during the set-down period.

The second voltage supply unit comprises a second switch connected to a second variable resistor, and supplies the second voltage through the second switch during the set-down period.

The plasma display apparatus further comprises a fourth voltage supply unit for supplying a fourth voltage, wherein the fourth voltage supply unit supplies the fourth voltage to the scan electrode during an address period.

A voltage level of the fourth voltage is from more than a ground voltage level to less than the first voltage level.

The second voltage supply unit sequentially supplies the second voltage to a plurality of scan electrodes during a scan period.

The first voltage supply unit comprises a first energy supply/recovery unit for supplying a positive voltage to the scan electrode or the sustain electrode and for recovering the positive voltage therefrom.

A voltage level of the positive voltage is about Vs/4.

The second voltage supply unit comprises a second energy supply/recovery unit for supplying a negative voltage to the scan electrode or the sustain electrode and for recovering the negative voltage therefrom.

A voltage level of the negative voltage is about −Vs/4.

A plasma display apparatus according to another embodiment of the present invention comprises a plasma display panel comprising a scan electrode and a sustain electrode, a first voltage supply unit connected to the scan electrode and the sustain electrode, for supplying a first voltage to the sustain electrode during an address period and for supplying the first voltage to the scan electrode or the sustain electrode during a sustain period, and a second voltage supply unit connected to the scan electrode and the sustain electrode, for supplying a second voltage with a polarity inverse to the polarity of the first voltage to an electrode counter to an electrode to which the first voltage is supplied during the sustain period.

A voltage level of the first voltage is Vs/2.

A voltage level of the second voltage is −Vs/2.

A method of driving a plasma display apparatus that implements images during one frame by combining a plurality of subfields, each comprising a set-up period, a set-down period, an address period and a sustain period, the method comprising the steps of supplying a first voltage to a sustain electrode during the address period, and supplying the first voltage to any one of a scan electrode and the sustain electrode during the sustain period, and supplying a second voltage with a polarity inverse to the polarity of the first voltage to an electrode counter to an electrode to which the first voltage is supplied.

### First Embodiment

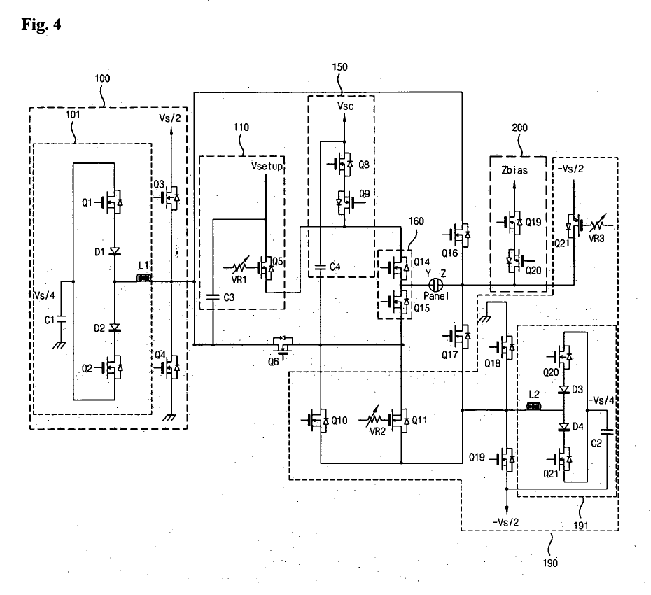

FIG. 4 is a circuit diagram of a plasma display apparatus according to a first embodiment of the present invention.

As shown in FIG. 4, the plasma display apparatus according to a first embodiment of the present invention comprises a first voltage supply unit 100 and a second voltage supply unit 190 for supplying first and second voltages having a different polarity during a sustain period. The first voltage supply unit 100 according to a first embodiment of the present invention is connected to a scan electrode Y and a sustain electrode Z and the second voltage supply unit 190 is connected to the scan electrode Y and a sustain electrode Z. That is, unlike the prior art, the plasma display apparatus according to the present invention does not comprise a scan driver and a sustain driver for driving the scan electrode Y and the sustain electrode Z, respectively, separately. Therefore, the circuit can be simplified and an amount in which a device is used can be reduced. Furthermore, the first voltage supply unit and the second voltage supply unit can be substantially constructed using an integrated driving board. The term “integrated driving board” refers to a board that drives both the scan electrode and the sustain electrode using one driving board.

Meanwhile, in the first embodiment of the present invention, during a sustain period, a first voltage, i.e., a positive voltage (+Vs/2) and a second voltage, i.e., a negative voltage (−Vs/2) are alternately supplied to the scan electrode of the plasma display panel, and the first voltage and the second voltage are alternately supplied to the sustain electrode of the plasma display panel in an opposite order to the order in which the first voltage and the second voltage are alternately supplied to the scan electrode. That is, a sustain discharge can be sustained by supplying the first voltage (+Vs/2) and the second voltage (−Vs/2) whose voltage difference is a sustain discharge voltage (Vs). As described above, sustain driving is made possible with a voltage of ½ of the sustain discharge voltage (Vs) unlike the prior art.

Furthermore, since the second voltage is applied to the sustain electrode during a set-up period, a voltage difference with a positive set-up voltage supplied to the scan electrode can be formed in which wall charges can be sufficiently accumulated. Therefore, a voltage level of the set-up voltage can be lowered in comparison with the prior art. Furthermore, since the first voltage is applied to the sustain electrode during a set-down period, a voltage difference with a negative set-down voltage supplied to the scan electrode can be formed in which wall charges can be sufficiently erased. Therefore, a voltage level of the negative set-down voltage can be raised in comparison with the prior art. As described above, an amount of a voltage applied in the reset period can be reduced.

An operating characteristic of the plasma display apparatus according to the first embodiment of the present invention will be described in more detail below.

The plasma display apparatus according to a first embodiment of the present invention comprises the first voltage supply unit 100, the second voltage supply unit 190, a third voltage supply unit 110, a fourth voltage supply unit 150 and a fifth voltage supply unit 200.

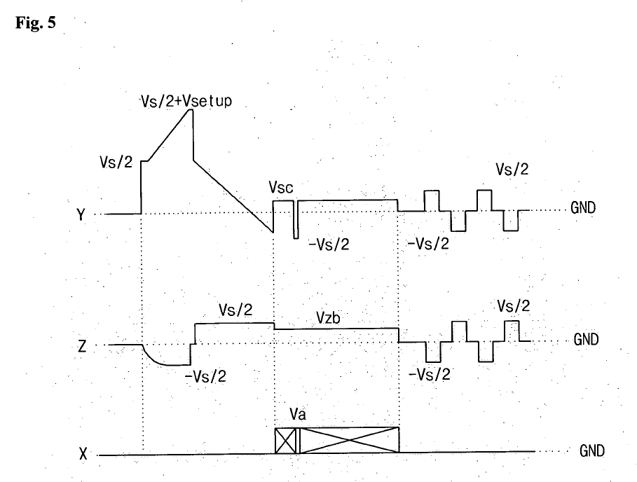

The first voltage supply unit 100 supplies the first voltage whose voltage level is (Vs/2) to the scan electrode and the sustain electrode. That is, as will be shown in FIG. 5, during each period, the first voltage whose voltage level is (Vs/2) is supplied to the scan electrode and the sustain electrode. This will be described in detail later on with reference to FIG. 5. Meanwhile, the first voltage supply unit 100 comprises a first energy supply/recovery unit 101 that supplies a positive voltage to the scan electrode or the sustain electrode and recovers the positive voltage therefrom. That is, the first energy supply/recovery unit 101 recovers reactive power supplied to the scan electrode or the sustain electrode formed in the plasma display panel and supplies the reactive power thereto again, thus improving energy efficiency. To this end, the first energy supply/recovery unit 101 comprises a first capacitor C1 and a first inductor L1. A voltage level of energy, which is supplied and supplied in the first capacitor C1, becomes approximately Vs/4. A fifth switch Q6 switches and controls a current path along which positive energy is supplied and recovered from the first voltage supply unit 100.

The second voltage supply unit 190 supplies the second voltage whose voltage level is (−Vs/2) to the scan electrode and the sustain electrode. That is, as will be shown in FIG. 5, during each period, the second voltage supply unit 190 supplies the second voltage to the scan electrode and the sustain electrode. This will be described in detail later on with reference to FIG. 5. Meanwhile, the second voltage supply unit 190 comprises a second energy supply/recovery unit 191 that supplies a negative voltage to the scan electrode or the sustain electrode and recovers the positive voltage therefrom. That is, the second energy supply/recovery unit 191 recovers reactive power supplied to the scan electrode or the sustain electrode formed in the plasma display panel and supplies the reactive power thereto again, thus improving energy efficiency. To this end, the second energy supply/recovery unit 191 comprises a second capacitor C2 and a second inductor L2. A voltage level of energy, which is supplied and supplied in the second capacitor C2, becomes approximately −Vs/4.

The second voltage supply unit 190 comprises a second switch Q11 to which a second variable resistor VR2 is connected. Therefore, the second voltage is supplied to the scan electrode during the set-down period while forming a ramp-down waveform.

The second voltage supply unit 190 can further comprise a third switch Q21 to which a third variable resistor VR3 is connected in order to stably accumulate wall charges thereon during the set-up period. That is, as the second voltage is supplied to the sustain electrode through the third switch Q21 during the set-up period, the second voltage is supplied to the sustain electrode while forming the ramp-down waveform. Furthermore, a fourth switch Q10 comprised in the second voltage supply unit 190 is a switch for controlling the supply of the second voltage, i.e., the scan voltage to the scan electrode during an address period.

The third voltage supply unit 110 supplies a third voltage to the scan electrode during the set-up period. The third voltage is a positive voltage and is supplied to the scan electrode as a set-up voltage with it being combined with the first voltage supplied from the first voltage supply unit 100 during the set-up period. The third voltage supply unit 110 comprises a first switch Q5 to which a variable resistor VR1 is connected. The third voltage supply unit 110 supplies the third voltage through the first switch Q5 during the set-up period, so that a set-up pulse forms a ramp-up waveform.

The fourth voltage supply unit 150 supplies a fourth voltage, i.e., a scan bias voltage (Vsc) to the scan electrode during the address period. A voltage level of the fourth voltage is from more than a ground voltage level to less than a first voltage level. The reason why the voltage level of the fourth voltage is from more than the ground voltage level to less than the first voltage level is that there is a possibility that an erroneous discharge may be generated due to a surface discharge between the scan electrode and the sustain electrode although an address voltage (Va) is not applied to the address electrode since the scan voltage falls up to the negative second voltage (−Vs/2).

The fifth voltage supply unit 200 supplies a fifth voltage (Vzb) to the sustain electrode during the address period. Since a positive fifth voltage (Vzb) is supplied to the sustain electrode, a voltage difference between the scan electrode and the sustain electrode during the address period can be reduced.

The scan IC 160 is directly connected to the scan electrode and controls the supply of a voltage to the scan electrode.

A sixth switch Q16 switches and controls a current path along which the first voltage is supplied to the sustain electrode.

A seventh switch Q17 switches and controls a current path along which the second voltage is supplied to the sustain electrode.

FIG. 5 is a view illustrating a driving waveform of the plasma display apparatus according to a first embodiment of the present invention.

As shown in FIG. 5, the plasma display apparatus according to the first embodiment of the present invention is driven with one frame being divided into a reset period for initializing the entire cells, an address period for selecting cells to be discharge and a sustain period for sustaining the discharge of selected cells.

In the set-up period of the reset period, the first voltage (Vs/2) of the first voltage supply unit 100 and the third voltage (Vsetup) of the third voltage supply unit 110 are combined and are then supplied to the first switch Q5. The first switch Q5 supplies a voltage having a predetermined slant while having its channel width controlled by the first variable resistor VR1. The voltage having the predetermined slant is supplied to the scan electrode Y via the switch Q14 at the top end of the scan IC 160. Though the process, the set-up voltage (Vs/2+Vsetup) forming the ramp-up waveform is supplied to the entire scan electrodes Y at the same time as shown in FIG. 5.

Furthermore, the second voltage (−Vs/2) of the second voltage supply unit 190 is supplied to the sustain electrode Z via the third switch Q21. Therefore, a voltage level of the set-up waveform, which is applied to the scan electrode during the set-up period while forming a voltage difference between the scan electrode Y and the sustain electrode Z, can be lowered. Furthermore, as the second voltage (−Vs/2) is supplied via the third switch, the ramp-down waveform that gradually falls is supplied to the sustain electrode, so that wall charges can be stably accumulated.

As described above, a weak dark discharge is generated within the discharge cells of the whole screen through the set-up period. The set-up discharge causes positive wall charges to be accumulated on the address electrode and the sustain electrode and negative wall charges to be accumulated on the scan electrode.

During the set-down period, the second voltage (−Vs/2) of the second voltage supply unit 190 is supplied to the scan electrode via the second switch Q11. Therefore, as shown in FIG. 5, the ramp-down waveform is supplied to the scan electrode and a voltage of the scan electrode falls up to (−Vs/2).

Furthermore, the first voltage (Vs/2) of the first voltage supply unit 190 is supplied to the sustain electrode via the sixth switch Q16. Therefore, a sufficient voltage difference for erasing wall charges is formed between the scan electrode and the sustain electrode. In the first embodiment of the present invention, it has been described that the first voltage is supplied to the sustain electrode during the set-down period. However, the positive fifth voltage (Vzb) of the fifth voltage supply unit 200 can be supplied to the sustain electrode during the set-down period.

As described above, an erase discharge is generated between the scan electrode and the address electrode and between the scan electrode and the sustain electrode within cells through the set-down period. Therefore, wall charges formed within the cells can be sufficiently erased. The set-down waveform causes wall charges of the degree in which an address discharge can be stably generated within cells on which images will be displayed during the sustain period to uniformly remain within the cells.

In the address period, the fourth voltage (Vsc) of the fourth voltage supply unit 150 is supplied to the entire scan electrodes. In a state where the fourth voltage is set to a reference voltage, the second voltage (−Vs/2) of the second voltage supply unit 150 is sequentially supplied to each scan electrode via the fourth switch Q10. The sustain electrode is supplied with the fifth voltage (Vzb) of the fifth voltage supply unit 200 in order to prevent an erroneous discharge with the scan electrode.

While a negative scan voltage is sequentially applied to the scan electrodes as described above, a positive address voltage is applied to the address electrode in synchronization with the scan voltage. As a voltage difference between the scan voltage and the address voltage and a wall voltage generated in the reset period are added, an address discharge is generated within discharge cells to which the address voltage is applied. Wall charges of the degree in which a discharge can be generated when a sustain voltage is supplied are formed within cells selected by an address discharge. Meanwhile, the sustain electrode is supplied with a positive bias voltage (Vzb) so that an erroneous discharge with the scan electrode is not generated by reducing a voltage difference with the scan electrode during the address period.

During the sustain period, the first voltage (Vs/2) is supplied from the first voltage supply unit 100 to the scan electrode or the sustain electrode. At the same time, the second voltage (−Vs/2) is supplied from the second voltage supply unit 190 to a counter electrode to an electrode to which the first voltage (Vs/2) is supplied. A sustain discharge, i.e., a display discharge is generated between the scan electrode and the sustain electrode in cells selected by the address discharge whenever the sustain discharge voltage (Vs) is supplied as the wall voltage within the cells and the sustain discharge voltage (Vs) are added.

Therefore, the plasma display apparatus according to the first embodiment of the present invention can obtain the same characteristic as that obtained by the related art driving waveform and can save the cost of constructing a circuit.

### Second Embodiment

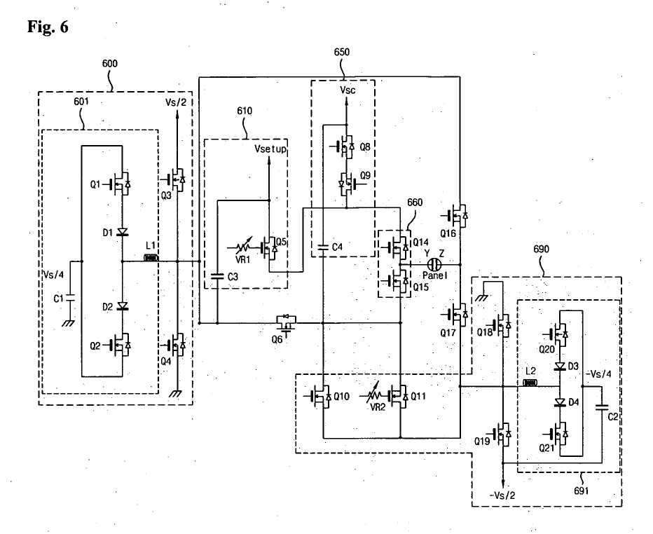

FIG. 6 is a circuit diagram of a plasma display apparatus according to a second embodiment of the present invention.

As shown in FIG. 6, the plasma display apparatus according to the second embodiment of the present invention comprises a first voltage supply unit 600, a second voltage supply unit 690, a third voltage supply unit 610 and a fourth voltage supply unit 650.

The plasma display apparatus according to the second embodiment of the present invention uses the positive bias voltage (Vzb) as the first voltage (Vs/2) unlike the plasma display apparatus according to the first embodiment of the present invention, which has been described with reference to FIG. 4. That is, the fifth voltage supply unit 200 of FIG. 4 can be obviated by supplying the first voltage of the first voltage supply unit 600 to the sustain electrode Z during the address period. It is thus possible to further reduce the use of a voltage source and an element and thus to save the manufacturing cost of a plasma display apparatus more effectively. Meanwhile, in the second embodiment of the present invention, the third switch Q21 of FIG. 4 can also be omitted in order to save the manufacturing cost.

The plasma display apparatus according to the second embodiment of the present invention also comprises the first voltage supply unit 600 and the second voltage supply unit 690 for supplying a first voltage and a second voltage having a different polarity during the sustain period in the same manner as the plasma display apparatus according to the first embodiment of the present invention. The first voltage supply unit 600 according to the second embodiment of the present invention is connected to the scan electrode Y and the sustain electrode Z, and the second voltage supply unit 690 is connected to the scan electrode Y and the sustain electrode Z. The same construction and operating characteristic of the plasma display apparatus according to the second embodiment of the present invention as those of the plasma display apparatus according to the first embodiment of the present invention will be omitted in order to avoid redundancy.

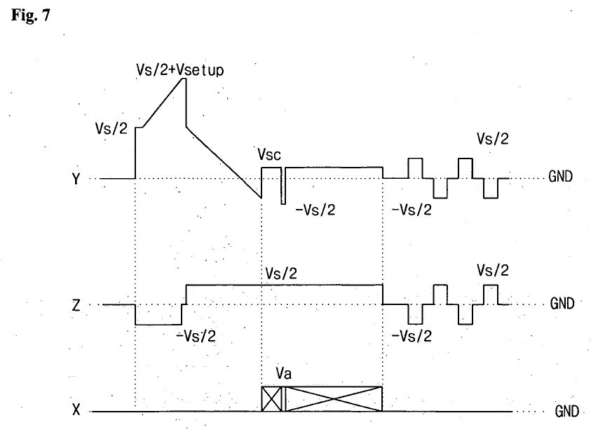

FIG. 7 is a view illustrating a driving waveform of the plasma display apparatus according to the second embodiment of the present invention.

As shown in FIG. 7, the plasma display apparatus according to the second embodiment of the present invention is driven with one frame being divided into a reset period for initializing the entire cells, an address period for selecting cells to be discharge and a sustain period for sustaining the discharge of selected cells.

In the address period according to the second embodiment of the present invention, a fourth voltage (Vsc) of the fourth voltage supply unit 650 is supplied to the entire scan electrodes Y. In a state where the fourth voltage is set to a reference voltage, the second voltage (−Vs/2) of the second voltage supply unit 650 is sequentially supplied to each of the scan electrodes Y via the fourth switch Q10. The sustain electrode Z is supplied with the first voltage (Vs/2) of the first voltage supply unit 600 in order to prevent an erroneous discharge with the scan electrode Y.

Therefore, the plasma display apparatus according to the second embodiment of the present invention can obtain the same characteristic as that obtained by the driving waveform according to the first embodiment of the present invention. Furthermore, the plasma display apparatus according to the second embodiment of the present invention can save the cost of constructing a circuit. The reset period and the sustain period have been sufficiently described with reference to FIG. 5. Therefore, description thereof will be omitted.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode and a sustain electrode;
a first voltage supply unit connected to the scan electrode and the sustain electrode, for supplying a first voltage to the scan electrode or the sustain electrode during a sustain period; and
a second voltage supply unit connected to the scan electrode and the sustain electrode, for supplying a second voltage with a polarity inverse to the polarity of the first voltage to an electrode counter to an electrode to which the first voltage is supplied during the sustain period.

2. The plasma display apparatus as claimed in claim 1, wherein a voltage difference between the first voltage and the second voltage is the voltage level for a sustain discharge voltage (Vs).

3. The plasma display apparatus as claimed in claim 2, wherein a voltage level of the first voltage is Vs/2.

4. The plasma display apparatus as claimed in claim 2, wherein a voltage level of the second voltage is −Vs/2.

5. The plasma display apparatus as claimed in claim 1, further comprising a third voltage supply unit for supplying a third voltage to the scan electrode during a set-up period.

6. The plasma display apparatus as claimed in claim 5, wherein the first voltage supply unit and the third voltage supply unit supply a combination of the first voltage and the third voltage to the scan electrode during the set-up period, and
the second voltage supply unit supplies the second voltage to the sustain electrode.

7. The plasma display apparatus as claimed in claim 5, wherein the third voltage supply unit comprises a first switch connected to a first variable resistor, and supplies the third voltage through the first switch during the set-up period.

8. The plasma display apparatus as claimed in claim 1, wherein the second voltage supply unit supplies the second voltage to the scan electrode during a set-down period, and
the first voltage supply unit supplies the first voltage to the sustain electrode during the set-down period.

9. The plasma display apparatus as claimed in claim 8, wherein the second voltage supply unit comprises a second switch connected to a second variable resistor, and supplies the second voltage through the second switch during the set-down period.

10. The plasma display apparatus as claimed in claim 1, further comprising a fourth voltage supply unit for supplying a fourth voltage, wherein the fourth voltage supply unit supplies the fourth voltage to the scan electrode during an address period.

11. The plasma display apparatus as claimed in claim 10, wherein a voltage level of the fourth voltage is from more than a ground voltage level to less than the first voltage level.

12. The plasma display apparatus as claimed in claim 1, wherein the second voltage supply unit sequentially supplies the second voltage to a plurality of scan electrodes during a scan period.

13. The plasma display apparatus as claimed in claim 1, wherein the first voltage supply unit comprises a first energy supply/recovery unit for supplying a positive voltage to the scan electrode or the sustain electrode and for recovering the positive voltage therefrom.

14. The plasma display apparatus as claimed in claim 13, wherein a voltage level of the positive voltage is about Vs/4.

15. The plasma display apparatus as claimed in claim 1, wherein the second voltage supply unit comprises a second energy supply/recovery unit for supplying a negative voltage to the scan electrode or the sustain electrode and for recovering the negative voltage therefrom.

16. The plasma display apparatus as claimed in claim 15, wherein a voltage level of the negative voltage is about −Vs/4.

17. A plasma display apparatus comprising:
a plasma display panel comprising a scan electrode and a sustain electrode;
a first voltage supply unit connected to the scan electrode and the sustain electrode, for supplying a first voltage to the sustain electrode during an address period and for supplying the first voltage to the scan electrode or the sustain electrode during a sustain period; and
a second voltage supply unit connected to the scan electrode and the sustain electrode, for supplying a second voltage with a polarity inverse to the polarity of the first voltage to an electrode counter to an electrode to which the first voltage is supplied during the sustain period.

18. The plasma display apparatus as claimed in claim 17, wherein a voltage level of the first voltage is Vs/2.

19. The plasma display apparatus as claimed in claim 17, wherein a voltage level of the second voltage is −Vs/2.

20. A method of driving a plasma display apparatus that implements images during one frame by combining a plurality of subfields, each comprising a set-up period, a set-down period, an address period and a sustain period, the method comprising the steps of:
supplying a first voltage to a sustain electrode during the address period; and
supplying the first voltage to any one of a scan electrode and the sustain electrode during the sustain period, and supplying a second voltage with a polarity inverse to the polarity of the first voltage to an electrode counter to an electrode to which the first voltage is supplied.
